(19) United States
(12) Patent Application Publication
(10) Pub. No.: US 2010/0114734 A1
(43) Pub. Date: May 6, 2010

(54) TELEMATICS COMPUTER SYSTEM AND METHOD FOR MOBILE WIRELESS RETAIL ORDER PROCESSING AND FULFILLMENT

(75) Inventors: Thomas J. Giuli, Ann Arbor, MI (US); Krishnaswamy Venkatesh Prasad, Ann Arbor, MI (US); Henry Heping Huang, Canton, MI (US); John Matthew Ginder, Plymouth, MI (US)

Correspondence Address: BROOKS KUSHMAN P.C./FGTL, 1000 TOWN CENTER, 22ND FLOOR, SOUTHFIELD, MI, 48075-1238, US

(73) Assignee: FORD GLOBAL TECHNOLOGIES, LLC, Dearborn, MI (US)

(21) Appl. No.: 12/612,985

(22) Filed: Nov. 5, 2009

Related U.S. Application Data
(60) Provisional application No. 61/111,495, filed on Nov. 5, 2008.

(51) Int. Cl. G06Q 30/00; G06Q 20/00

(52) U.S. Cl. 705/26

(57) ABSTRACT

A method for making a purchase using a vehicle computing system includes receiving input to the vehicle computing system instructing order initiation. The method also includes receiving a selection at the vehicle computing system of a merchant from which to order. The method further includes receiving an order at the vehicle computing system, determining an address of the merchant to which the order was placed and providing directions to the address. These can be provided as, for example, turn by turn directions spoken and/or displayed on a nav display. Finally, the exemplary method includes processing a payment for the order.

### CROSS-REFERENCE TO RELATED APPLICATIONS

This application claims the benefit of U.S. provisional application Ser. No. 61/111,495 filed Nov. 5, 2008.

### BACKGROUND

1. Technical Field

Embodiments of the present invention generally relate to vehicle telematics, and in particular, to a computer system and method for mobile wireless retail order processing and fulfillment.

2. Background Art

Consumers are growing increasingly used to having shopping integrated into everyday aspects of their life. Cellular phones can connect to the internet and function as shopping platforms. Online shopping, through a computer, has become a popular method of making purchases.

Consumers like these options because they save time, energy and effort. They prevent waiting in lines and allow people to multitask.

Many aspects of consumerism, however, have not been streamlined in this manner. Purchases, such as food purchases, are still made from a drive through window. Food orders are still called in with a telephone. Some restaurants, such as pizza parlors, offer online ordering and pickup, but this requires a user to either a) stop a vehicle and use an internet phone to place an order; or b) be in the proximity of an internet connected computer.

Neither of the above options are very convenient if, for example, a user is traveling home from work and wishes to pick up dinner.

### SUMMARY

In a first illustrative embodiment, a method for making a purchase using a vehicle computing system includes receiving input to the vehicle computing system instructing order initiation. The method also includes receiving a selection at the vehicle computing system of a merchant from which to order.

The method further includes receiving an order at the vehicle computing system, determining an address of the merchant to which the order was placed and providing directions to the address. These can be provided as, for example, turn by turn directions spoken and/or displayed on a nav display. Finally, the exemplary method includes processing a payment for the order.

In a second illustrative embodiment, a method for making a purchase using a vehicle computing system includes establishing wireless communication over a local network between the vehicle computing system and a merchant system from which an order is to be placed.

This exemplary method also includes providing a list of options which may be ordered and receiving an order at the vehicle computing system.

The method further includes transmitting the order to the merchant from the vehicle computing system and processing payment for the order.

A third exemplary method for making a purchase using a vehicle computing system includes establishing communication between the vehicle computing system and a merchant system from which an order is to be placed.

This illustrative method also includes providing a list of options which may be ordered and receiving an order at the vehicle computing system.

The method further includes transmitting the order to the merchant from the vehicle computing system, processing payment for the order, and sending one or more identifying traits of the vehicle to the merchant system.

### BRIEF DESCRIPTION OF THE DRAWINGS

FIG. 1 is a block diagram illustrating embodiments of a telematics computing system for implementing aspects of the present invention;

FIG. 2 is a block flow diagram illustrating a methodology for implementing an embodiment of the present invention;

FIG. 3 is a block flow diagram illustrating a methodology for implementing another embodiment of the present invention;

FIG. 4a shows exemplary order processing for a vehicle in motion;

FIG. 4b shows an alternative non-limiting method for ordering food from a vehicle while driving;

FIG. 5 shows an exemplary illustration of a process for determining a restaurant;

FIG. 6 shows an exemplary process for ordering food while at a restaurant location;

FIG. 7 shows an exemplary process for a menu assembly and display; and

FIG. 8 shows an illustrative example of a system for processing a payment to a merchant.

### DETAILED DESCRIPTION

### System Architecture Embodiments

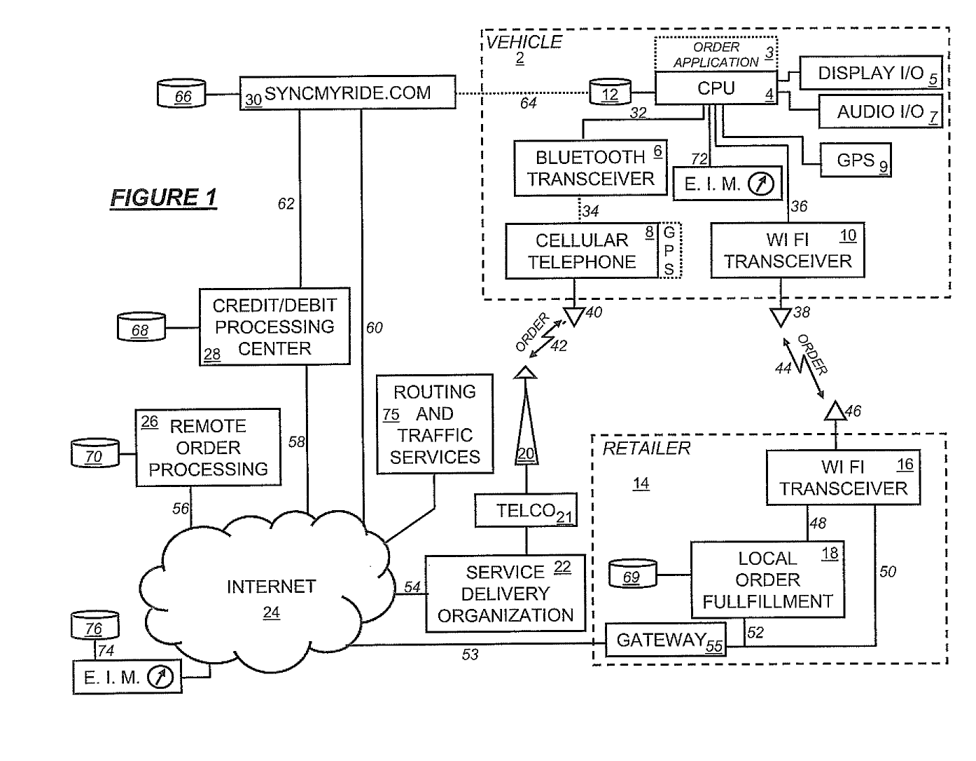

FIG. 1 is a block diagram illustrating multiple embodiments of a telematics computing system for implementing aspects of the present invention. Embodiments and implementations of the present invention are not limited to those illustrated and described with respect to FIG. 1. Embodiments of the present invention may be implemented in a manner unique to that illustrated in FIG. 1.

In one embodiment of the present invention, vehicle system 2 includes a central processing unit 4. CPU 4 may have an associated power supply (not shown) and random access memory (not shown). CPU 4 also may include associated persistent memory 12. Persistent memory 12 may be a hard drive, a flash drive, or other form of non-volatile memory. Executing on CPU 4 may be one or more order applications 3 as described in greater detail below. CPU 4 is in communication with display circuitry 5 for visually outputting information to a user of vehicle system 2, and for receiving input information (e.g., touch screen) from a user. CPU 4 may also be in communication with audio circuitry 7 for outputting and receiving input information. An audio output circuit may include a digital-to-analog converter and an amplifier for audibly playing information to a user of vehicle system 2 through the vehicle speaker system (not shown). Similarly, audio circuitry 7 may include an analog-to-digital converter for receiving spoken commands from a user, encoding those spoken words into digital information, and interpreting that digital information as command input to CPU 4.

CPU 4 may also be in communication 32 with BLUETOOTH transceiver 6. BLUETOOTH transceiver 6 may be configured for communication with (e.g., paired with) one or more local wireless devices, such as a cellular telephone 8, headset, or other device configured for wireless communication utilizing the BLUETOOTH protocol 34. In the embodiment illustrated in FIG. 1, the local wireless device is a cellular telephone 8 having local BLUETOOTH connectivity to BLUETOOTH transceiver 6. One example of this configuration is FORD MOTOR COMPANY′S SYNC SYSTEM. Communication 34 between cellular telephone 8 and BLUETOOTH transceiver 6 may be bidirectional, and may include functionality for sending and receiving cellular telephone calls. For example, cellular telephone antenna 40 may communication over cellular wireless link 42 with cellular tower 20 having connectivity to telephone company 21. Telephone company 21 may be connected (not shown) with existing telephone network systems. As described in greater detail below, telephone company 21 may also have connectivity with service delivery network 22.

Vehicle system 2 may also include a Wi-Fi transceiver 10 having connectivity to CPU 4. Wi-Fi transceiver 10 may be configured to bilaterally communicate information between CPU 4 and a remote computer system or computer network. In one embodiment of the present invention, Wi-Fi transceiver 10 may communicate bi-directionally with retailer 14 over wireless communication link 44. Wi-Fi transceiver 10 and 14 may communicate using an IEEE 802.11 wireless modulation protocol, such as 802.11b or 802.11g. Other wireless communication protocols may also be used. For example CARTEL network nodes enabling fast Wi-Fi connectivity may be implemented. The CARTEL project is an ongoing telematics project at Massachusetts Institute of Technology's Department of Electrical Engineering and Computer Science (http://cartel.csail.mit.edu/doku.php).

CPU 4 may also be in communication with, or otherwise execute, an environmental impact meter 72. The functionality of the environmental impact meter 72 is described in greater detail below. In an alternative embodiment, environmental impact meter 74 may be located remotely from vehicle 2, may be access through a variety of communication channels including but not limited to Telco 21 via wireless communication link 42, or Wi-Fi transceiver 16 via wireless communication link 44.

CPU 4 may also be in communication with a global positioning system (GPS) module 9. GPS module 9 may wirelessly receive geographical positioning data from GPS satellites (not shown) orbiting earth. GPS module 9 may provide raw geographical positioning data, or latitude/longitude coordinates, to CPU 4 to identify the geographic location of the automobile in which vehicle system 2 is installed. In an alternative embodiment, GPS module 9 is an integrated component of cellular telephone 8. In this embodiment, CPU 4 may receive geographical position information wirelessly from the cellular telephone via BLUETOOTH communication link 34.

Retailer 14 may be any commercial retailer, including but not limited to a restaurant, supermarket or convenience store. Retailer 14 may have network connectivity 53 with Internet 24 via gateway 55. Wi-Fi transceiver 16 located within, or in the proximity of, retailer 14 may have access to the Internet 24 via gateway 55. In addition, a local order fulfillment system 18 may have Internet connectivity 24 via gateway 55. Wi-Fi transceiver 16 may have connectivity to local order fulfillment system 18 via network link 48. As discussed in greater detail below, retailer 14 may wirelessly negotiate orders via wireless link 44 with vehicle 2, as illustrated in FIG. 1. Alternatively, orders may be negotiated between vehicle 2 and retailer 14 via wireless link 42 utilizing service delivery network 22 having connectivity to the Internet 24, and thus retailer 14.

SYNCMYRIDE.com represents a website, or collection of websites, on the Internet 24. In one embodiment of the present invention, that website is www.SYNCMYRIDE.com. Website 30 may be in operable communication with database 66 for storing information presented to, and received from, browsers of website 30. Website 30 may have a communication link 62 with credit/debit processing center 28. In an alternative embodiment, website 30 may communicate with credit/debit processing center 28 via the Internet (e.g., links 58 and 60). Credit/debit processing center 28 may be in operable communication with database 68 for storing customer credit/debit records, as described in greater detail below.

Remote order processing system 26 may be provided having connectivity 56 to Internet 24. Remote order processing system 26 may also include an associated database 70 for recording information pertaining to customer order processing, as described in greater detail below.

Of course, website 30, credit/debit processing center 28, remote order processing system 26, service delivery network 22, and local order fulfillment system 18 may all include one or more computers having associated random access memory, persistent memory, and input/output devices (not shown).

### Wireless Retailing Process Embodiments

Embodiments of the system architecture described above enable wireless order processing and fulfillment from a vehicle at retailer station 14. In one embodiment, users of vehicle system 2 first register with credit/debit processing center 28 to establish a virtual credit account. For example, users of vehicle system 2 may access website 30 (e.g., www.SYNCMYRIDE.com) to provide a name, billing address, and credit card or bank account information to establish a virtual credit/debit account for wireless order processing with retailer 14. Additional information provided to credit/debit processing center 28 may include a vehicle identification number and user authentication attributes, such as a user name and password. Unique authentication attributes may permit multiple drivers or passengers of vehicle 2 to negotiate orders with retailer 14. Providing credit card and/or banking information to credit/debit processing center 28 will enable a cash or credit account for debiting at the time wireless orders are processed with retailer 14.

In one embodiment of the present invention, account information including available balance may be stored in persistent memory 12 at vehicle 2. In one embodiment, this information is downloaded from credit/debit processing center 28 through Internet 24, service delivery network 22 and Telco 21 to cellular telephone 8 having BLUETOOTH connectivity to CPU 4. In an alternative embodiment, the user of vehicle system 2 may download virtual account information from website/server 30 to a portable media device, such as a thumb drive, flash drive or flash memory for uploading via link 64 to database 12. In yet a third alternative embodiment, retailer 14 may access purchaser account information over link 53 to Internet 24 to credit/debit processing center 28. In this embodiment, customer account information may be stored in database 68.

In an implementation of the present invention in which no user account is established in advance of order processing, a buyer's banking or credit card information may be communicated to retailer 14 at the time of sale via wireless link 44 (or wireless link 42). Retailer 14 may then negotiate with credit/debit processing center 28 (e.g., Visa, American Express, Mastercard, etc.) for debiting a user's account in exchange for goods ordered at the point of sale.

In one embodiment of the present invention, a user of vehicle system 2 may access an order application 3 running on CPU 4 to place an order for food or merchandise at retailer 14. In one embodiment, display 5 may display a menu or selection of items for purchase at retailer 14. This menu may be archived in database 12, or downloaded at the point of sale via wireless links 42 or 44. In an alternative embodiment, display 5 displays a user's historical selections, facilitating the present menu/item selection. Historical selections may be archived at vehicle database 12, retailer database 69, and/or remote order processing database 70. If historical order selections are stored remote from vehicle system 2, they may be downloaded to vehicle system 2 at the time of order via wireless links 42 or 44.

Order selections may be made by a user operating touchscreen display 5, or by speaking selection commands utilizing audio I/O 7. Item selections may be communicated to retailer 14 in several different ways. In one embodiment, a customer order is communicated from Wi-Fi transceiver 10 located at vehicle 2 to Wi-Fi transceiver 16 located at retailer 14 over wireless link 44. In an alternative embodiment, an order may be communicated from cellular telephone 8 to the retailer 14 over cellular link 42 having connectivity to telephone company 21, and ultimately the Internet 24.

Preferably, information in addition to an order is received and/or archived in one or more of a plurality of different data storage locations illustrated in FIG. 1. This information may include customer identifier (e.g., name, user ID, etc.), authentication information (e.g. password, pin, etc.), a vehicle identification number, a time at which connectivity between Wi-Fi transceiver 10 and Wi-Fi transceiver 16 was established, a time of order, a time of order fulfillment, a time at which connectivity between Wi-Fi transceiver 10 and Wi-Fi transceiver 16 was lost, etc.

Information communicated from the retailer 14 to the vehicle system 2 may include an order confirmation, an order receipt, remaining available balance (if not tracked at vehicle system 2), etc. These items may be displayed on display 5 and archived in database 12.

Upon receipt of an order at Wi-Fi transceiver 16, the order and other information described above may be stored and processed locally at local order fulfillment station 18, and/or communicated via Internet gateway 55 to remote order processing center 26 and/or credit/debit processing center 28. In a preferred embodiment, retailer 14 receives the item order from vehicle system 2, and communicates the order over the Internet to remote order processing center 26 for processing. Order processing 26 may include approving the order and order fulfillment, and processing payment for the order. In this embodiment, retailer 14 is primarily responsible for physical order fulfillment 18, i.e. providing the ordered items to the user of vehicle system 2 after the order has been remotely processed and payment is verified by remote order processing 26 and/or credit/debit processing center 28. Of course, remote order processing center 26 and/or credit/debit processing center 28 may be one in the same. Alternatively, order processing, payment processing and order fulfillment may each occur locally at retailer 14.

In an alternative embodiment, an order from vehicle system may be communicated from cellular telephone 8 to service delivery organization 22 via telco 21. This configuration permits wireless orders to be placed for vehicles that do not have a Wi-Fi transceiver 10, retailers that do not have a Wi-Fi transceiver 16, or for the placement of orders in situations where vehicle system 2 is outside the range of vehicle Wi-Fi transceiver 10 and retailer Wi-Fi transceiver 16. In this embodiment, an order may be communicated over wireless link 42 using the narrow voice band (e.g. data over voice), or a broadband connection, depending on the capabilities of the cellular telephone 8 and its associated service provider. Service delivery organization may communicate the order over the Internet 24 to remote order processing center 26, credit/debit processing center 28 and/or retailer 14 for order processing, payment processing and order fulfillment.

Preferably, a plurality of data is collected concerning orders received at service delivery organization 22, retailer 14, remote order processing center 26, and/or credit/debit processing center 28. This data may include a customer identifier (e.g., name, user ID, etc.) associated with the order, authentication information (e.g. password, pin, etc.), vehicle identification information (e.g. make, model, color, etc.), a vehicle identification number, a time at which the order was placed, a time of order fulfillment, the location of the vehicle at the time of the order, a MAC address or other device identifier etc. The MAC ID may be, for example, the MAC ID of the cellular telephone 8 or the Wi-Fi transceiver 10. This information may be stored at retailer 14, remote order processing center 26, or at any of the other various data repository locations illustrated in FIG. 1.

In another embodiment, an environmental impact meter (E.I.M) 72 is provided as an aspect of vehicle system 2. The EIM 72 may be an application running on CPU 4, together with or separate from order application 3. The EIM 72 may operate to process information pertaining to the present order including but not limited to the type of vehicle in which the vehicle system 2 is installed, the time the order was placed, the time the order was fulfilled, the fuel consumption during order processing and fulfillment, etc. Based on this information, the EIM 72 may calculate an indication of environmental impact, such as a carbon emission value, fuel consumption value, pollution indicator, etc. In addition or alternatively, the EIM 72 may process information concerning average vehicle statistics, such as an average vehicle fuel consumption, average order processing time, etc, to calculate an indication of a relative environmental impact (or environmental savings) by the vehicle in which vehicle system 2 is installed as compared to other vehicles. Information concerning average vehicle statistics may be stored locally in persistent memory 12, or obtained from a remote source over wireless links 42 or 44. In yet another embodiment, statistics for specific vehicles may be used to create a comparison between the environmental impact of the order by the vehicle in which vehicle system 2 is installed, and one or more other specific vehicle types.

EIM 72 may run locally at vehicle system 2. Alternatively, an EIM 74 may execute remotely from vehicle system 2. The remote calculation of environmental impact or savings, or relative environmental impact or savings, may be downloaded to vehicle system 2 via wireless links 42 or 44.

In another embodiment, data recording a vehicle or user's historical orders sing vehicle system 2, and environmental impact for those historical orders, is archived and processed for marketing and advertising purposes. For example, discounts, sales, vouchers and other incentives may be made available to users of vehicle system 2 in the event a certain number or amount of purchase has been made at a particular retailer or franchise. In another example, discounts, sales, vouchers and other incentives may be made available to users of vehicle system 2 in the event the positive environmental impact value reaches a certain predefined lever. These discounts, sales, vouchers and other incentives may be defined by retailer 14 or retailer franchise. The discounts, sales, vouchers and other incentives may be downloaded to vehicle system 2 at the point of sale, or sent to users of vehicle system 2 by post mail or e-mail for subsequent redemption at retailer 14, credit/debit processing center 28, etc. In another embodiment, advertising may be downloaded to vehicle system 2 at the point of sale, or otherwise. CPU 2 may output the advertising at visual display 5, or audio output 7. Advertising may be defined by retailer 14, retailer franchise, credit/debit processing center 28, etc.

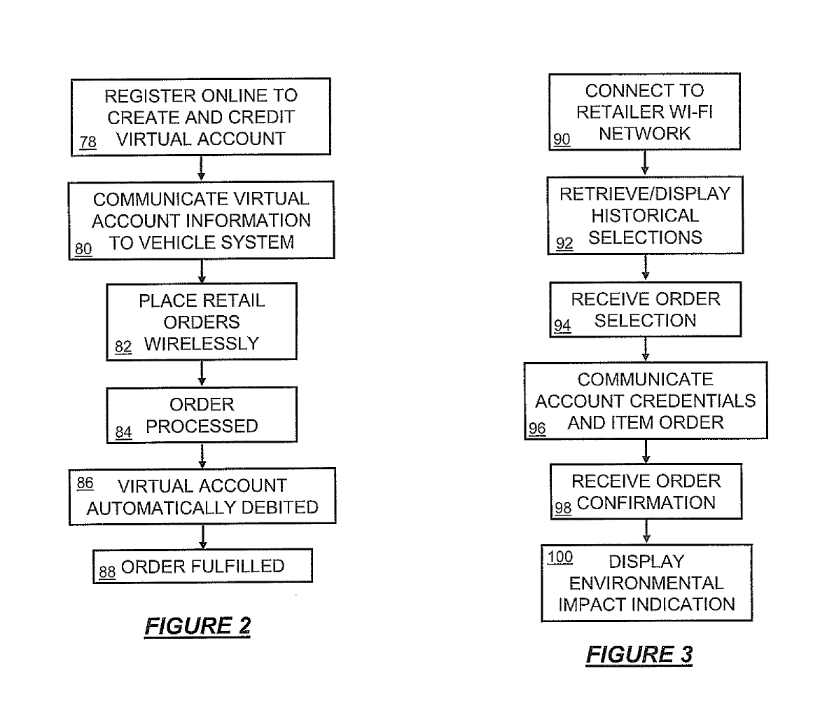

FIG. 2 illustrates a block flow diagram for implementing an embodiment of the present invention. At step 78, a user visits a website (e.g. www.SYNCMYRIDE.com) to create a virtual account for making purchases at retailer locations 14 using the vehicle system 2. Creating a virtual account may include submitting a name, billing information, and credentials, such as a username and password or PIN. The account may be credited using a credit or debit card, or other banking information.

At step 80, credentials concerning the account may be uploaded to the vehicle system 2 via thumb drive (not shown), wireless link 42 or 44, or via I/O modules 5 and 7.

At step 82, an order is placed from vehicle system 2 to retailer location 14. The order may be placed via cellular wireless link 42, Wi-Fi wireless link 44, or another wireless link.

At step 84, the retailer 14 or retailer franchise processes the order. The order may be processed locally at retailer 14, or remotely at remote order processing center 26. For remote order processing, orders may be communicated to remote order processing center 26 via the Internet. For orders placed remotely form the retailer 14, order processing may include determining the location of the vehicle with respect to the retailer 14, and estimating the arrival time of the vehicle. Estimating the arrival time of the vehicle may be based on the vehicle location information (e.g. latitude and longitude) received from vehicle system 2 together with the order, and routing and traffic information. Routing and traffic information may be available to retailer 14 over the Internet 24 from routing and traffic services center 75.

At step 86, the registered virtual account is debited to pay for the order. This may take place locally at the retailer 14, at the remote order processing center 26, or at credit/debit processing center 28.

At step 88, the order is fulfilled at retailer 14. Typically, this will include delivering the ordered items to the vehicle in which the vehicle system 2 is installed. As described above, the order wirelessly communicated to the retailer 14 may include the identity of the vehicle that placed the order (e.g. make, model, color, etc.). This information may permit the retailer 14 to distinguish the vehicle from other vehicles at the time or order fulfillment.

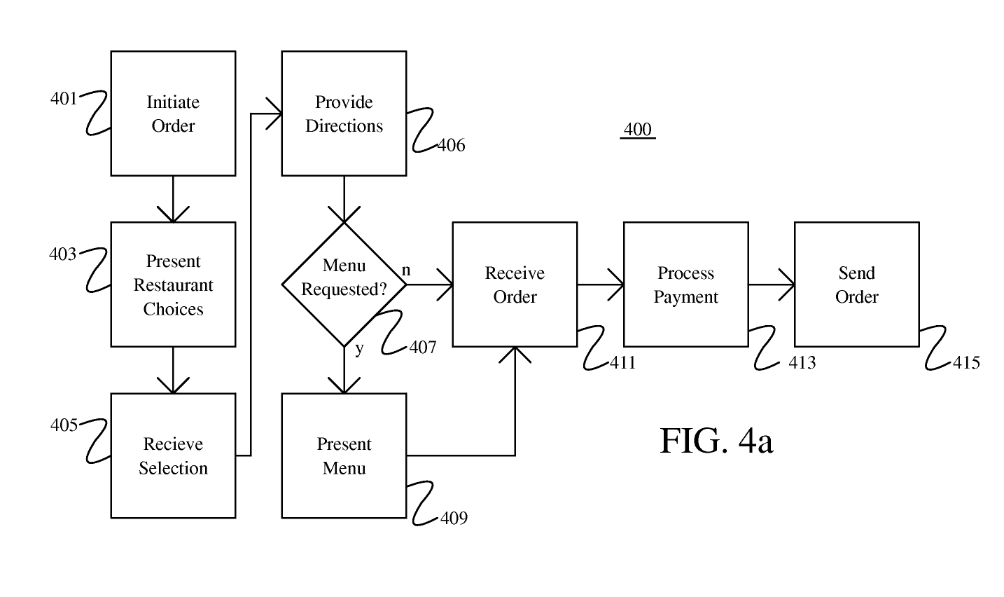

FIG. 3 illustrates a block flow diagram for implementing another embodiment of the present invention. At step 90, vehicle system 2 establishes a wireless connection (e.g. Wi-Fi) with retailer 14 over wireless link 44. As described above, communication with retailer 14 (remote order processing center 26) may also be established using wireless cellular link 42.

At step 92, a user's historical orders placed with retailer 14 or franchise may be displayed or audibly output at vehicle system 2 at I/O interface 5 or 7. Historical order information may be stored locally in persistent memory 12, at the retailer in persistent memory 96, and/or at the remote order processing center 26 in persistent memory 70.

At step 94, the vehicle system 2 receives the order from the user. The order may be received by touch-screen display 5, or by voice command at audio input 7. Preferably, the user is presented with historical selections for streamlining order placement.

At step 96, vehicle system 2 communicates the order, credential information and other information to retailer 14 via wireless link 44 (or remote order processing center 26 via wireless link 42). Credential information may include the user name and password or PIN of the ordering user. Other communicated information may include the vehicle identification number, vehicle location, vehicle make, model, color, time at which the order was placed, the number of passengers in the vehicle, etc.

In one implementation, a unique identification string may be communicated from vehicle system 2 to retailer 14 to uniquely identify the transaction. In an alternative embodiment, the unique identification string may be compiled at retailer 14, service delivery organization 22 or remote order processing center 26 or another location based on information received from vehicle system 2 in the context of the order. In one non-limiting example, the identification string may include one or more of a timestamp (e.g. YYYY:MM:DD:hhhh:mm:ss), a vehicle identification number, a vehicle location (e.g. latitude and longitude), or a MAC identifier or other device identifier. The MAC ID may be, for example, the MAC ID of the cellular telephone 8 or the Wi-Fi transceiver 10.

Other possible security implementations are also contemplated. For example, a verification system can detect the presence of a key fob with a particular vehicle identification signal. If the order is placed from a car in which the fob is present, then the order is assumed to be valid.

In still another illustrative implementation, a biometric, such as a fingerprint ID may be used. A vehicle can be equipped with a biometric scanner, and unless the proper biometric is included with the order, the order will not be processed.

A further illustrative implementation may use a security question. A simple question, such as, for example, a pet's name, may be asked to the user upon entry of an order. Failure to answer the question will result in non-processing of the order.

Other suitable security measures are also contemplated.

Some of these measures may be circumventable, e.g., a pet's name may be known, or a car may be stolen using keys (and thus the fob will be available).

In order to address this, a geographic fence may be user defined in order to restrict the area in which a particular account may be used. For example, if the user typically only travels within a 20 mile radius of a home, then the fence can restrict all usage outside of that zone. It may also be the case that the user regularly uses this feature of the vehicle within 10 miles of the home, so it may be possible to disable security questions, biometric scans, etc., within a limited radius, if the user desires.

At step 98, vehicle system 2 receives order confirmation, indicating that the order has been placed. Preferably, order confirmation is displayed at vehicle system 2. In one embodiment, a time of order fulfillment, or a countdown to order fulfillment, is also displayed.

At step 100, an environmental impact meter (EIM) or other environmental impact indication may be displayed at vehicle system 2. The EIM 72 may be an application running on CPU 4, together with or separate from order application 3. The EIM 72 may operate to process information pertaining to the present order including but not limited to the type of vehicle in which the vehicle system 2 is installed, the time the order was placed, the time the order was fulfilled, the fuel consumption during order processing and fulfillment, etc. Based on this information, the EIM 72 may calculate an indication of environmental impact, such as a carbon emission value, fuel consumption value, pollution indicator, etc. In addition or alternatively, the EIM 72 may process information concerning average vehicle statistics, such as an average vehicle fuel consumption, average order processing time, etc, to calculate an indication of a relative environmental impact (or environmental savings) by the vehicle in which vehicle system 2 is installed as compared to other vehicles. Information concerning average vehicle statistics may be stored locally in persistent memory 12, or obtained from a remote source over wireless links 42 or 44. In yet another embodiment, statistics for specific vehicles may be used to create a comparison between the environmental impact of the order by the vehicle in which vehicle system 2 is installed, and one or more other specific vehicle types.

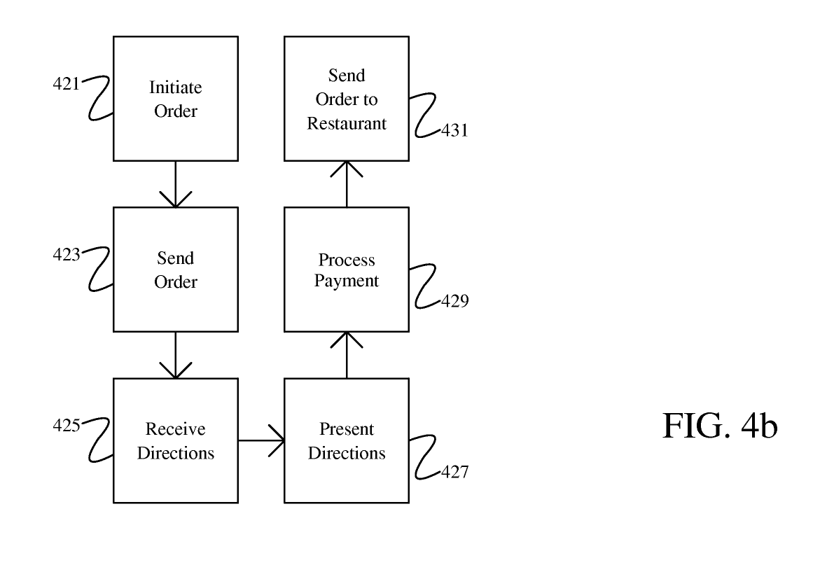

FIG. 4 shows an illustrative example of a process for placing an order while the user is driving to a restaurant location. While the examples herein are presented in terms of restaurants, the application of this invention is not so limited. For example, without limitation, a user could pre-order any product on the way to a business selling that product, to facilitate processing upon arrival. In one non-limiting example, the user could be presented with a list of movie times at a nearby theatre, and order tickets to a movie while on the way to the theatre. Other similar applications are also possible.

In the order processing 400 shown in FIG. 4a, the user, who is potentially driving, initiates a food order via voice command 401. While it is possible to use a touch sensitive display to place the order, it may be desirable to block this function while the vehicle is in motion, at least unless the user confirms that a passenger, not the driver, is inputting the order. Such a confirmation can even be further electronically confirmed by detection using existing vehicle systems of a passenger riding in the front of the vehicle.

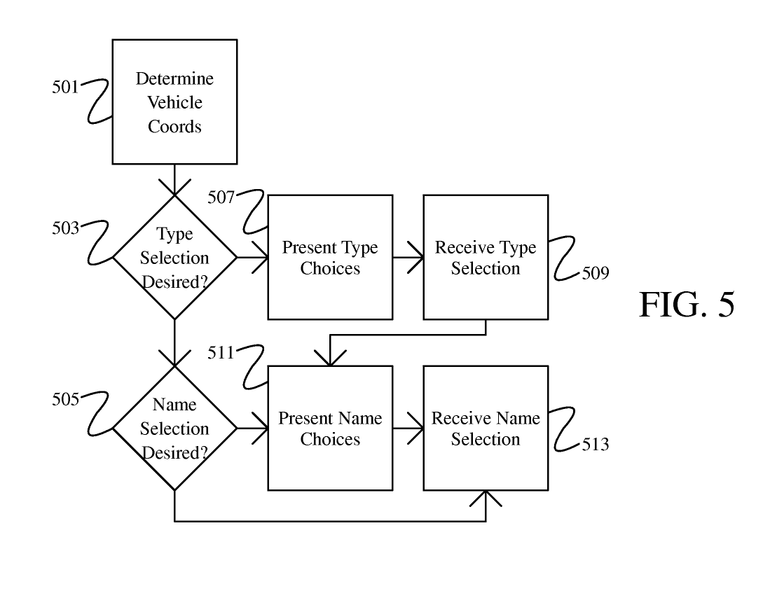

Once the order has been initiated, in this non-limiting example, a system (e.g., the vehicle based system, a central server, etc.) determines a present vehicle location, based on, for example, GPS coordinates, and then presents restaurant choices close to the vehicle 403. The restaurant determination is described in more detail with relation to FIG. 5.

The user selects a restaurant from the presented choices 405 (or simply inputs a desired restaurant). Based on the location of the restaurant and the location of the vehicle, driving directions are provided to a user 406.

If the user may then request a menu 407, which can be spoken to the user using the vehicle's audio system 409 (or displayed on a vehicle display, if, for example, a passenger is present). Once the menu has been heard, or if the user knows what food is desired, the user then speaks an order 411.

The order is then relayed to a restaurant 413 via, for example, the Internet, a wireless connection with the restaurant, or any other suitable means of conveying the order.

Payment is also processed for the order 415, in, for example, a manner described herein, or in another suitable manner.

FIG. 4b shows an alternative non-limiting method for ordering food from a vehicle while driving. In this illustrative embodiment, the user initiates the order by naming a restaurant and speaking a food order 421.

A vehicle system then sends the order 423, via a wireless connection, for example, to a restaurant central server or other server capable of delivering the order and providing restaurant location.

In response to receipt of the order, the central server sends back a location address and/or directions to the closest requested restaurant 425. The directions are then presented to the user 426. Payment is then processed by the central server 427, and the order is sent to the restaurant for processing 429.

FIG. 5 shows an exemplary illustration of a process for determining a restaurant. In this illustrative example, the vehicle coordinates are initially determined. This can be done, for example, using a GPS or similar system. Once the vehicle has determined the coordinates, it asks the driver if a restaurant type selection is desired 503. This could be a verbal or printed query, depending on whether a display is present and/or as passenger is present (visual queries can also be presented if no passenger is present, as desired).

If a type selection is desired, a list of restaurant types (e.g., fast food, hamburger, Italian, etc.) are presented or otherwise output 507. The system then receives a selection of a type from the user 509.

Once the type is known, a list of names within that type are presented 511, and the system receives a name selection from the user 513.

The determination of what types and names to present can be done by the vehicle system or by a centralized server to which the vehicle system connects. For example, the system could consider all restaurants within five miles of the user's location. If there are no restaurants within this radius, the system could look further out. The system could then list all the types of the restaurants falling within the searched area.

In another illustrative embodiment, the system could list a predefined list of types, and find the closest X number of restaurants corresponding to the selected type.

In a further embodiment, the system determines the name choices based on the selected type. As noted, these could be all within a certain distance, or the closest five different ones, etc.

If the user does no wish to select a type, the system may ask if the user wishes to see a list of restaurant names that are close to the present position of the vehicle 505. In this embodiment, the vehicle or a central server compiles a list of nearby restaurants for presentation to the user 511. The system then receives the selection (touch screen or verbal) of a name 513.

If the user doesn't wish to see/hear a list of types 503 or names 505, the user can just speak/type in the name and the system receives the name selection 513.

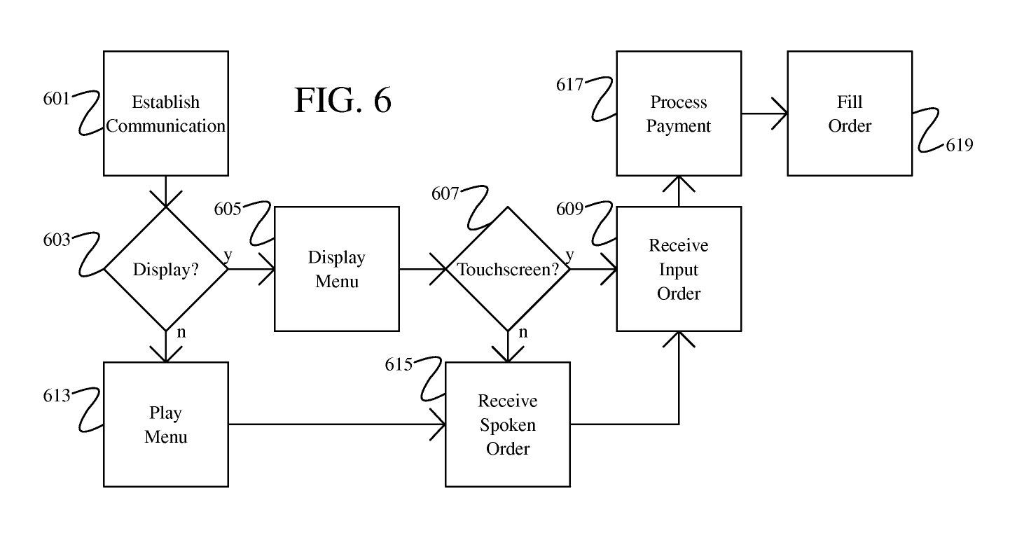

In another illustrative embodiment, shown in FIG. 6, the customer doesn't order food until arriving at a restaurant. This can allow the customer to sit in the parking lot and browse a menu selection at leisure. Additionally, since the customer is not sitting in a line of cars with the engine running, this will save on gas and reduce the emissions of the vehicle.

In this illustrative embodiment, the customer arrives at a location that has a wifi or other available connection. The vehicle communication/computing system or the restaurant's computing system establishes communication between the vehicle and the restaurant 601.

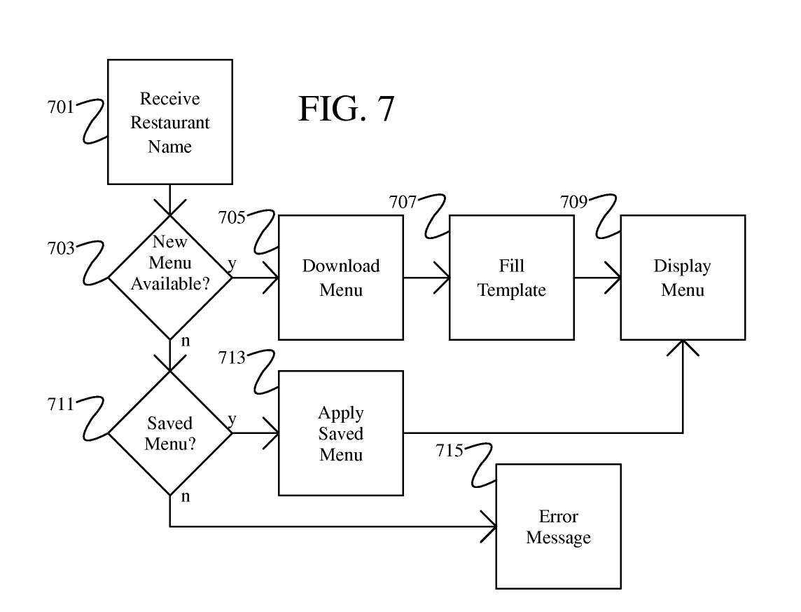

If the vehicle has a display, such as a touch screen or navigation display 603, then an in-vehicle menu is displayed 605. The menu display is described in more detail in relation to FIG. 7.

If the display is a touch screen display 607, the order can then be processed through the touch screen 609.

If the vehicle does not have a display, then a menu may be played for the user through the vehicle audio system 613, if desired 611.

If the vehicle does not have a touch screen display 607, then the customer may be able to order by speaking directly with an employee through a vehicle microphone and speakers 615.

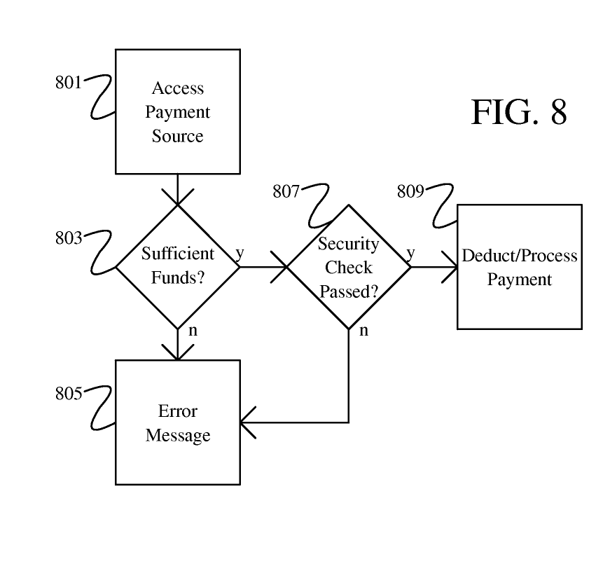

Once the order is placed, payment for the order will be processed 617. This process is described in more detail with respect to FIG. 8.

After processing of payment, the order is filled and the food is delivered to the customer 619, or the customer can pull through to the drive through window to receive the food.

In one illustrative embodiment, the menu to be displayed or played to the user is dynamically assembled. A non-limiting exemplary process for this assembly is shown in FIG. 7.

In this illustrative embodiment, the system receives the name of the restaurant from which ordering is to be performed 701. Next, in this embodiment, the system checks with either a central server or the restaurant to which the system is connected, to see if a menu is available 703. If a menu is available, the system downloads the components of the menu 705. It is also possible for a system to use a stored menu in place of downloading one.

Once the menu components are downloaded, they are filled into an appropriate template 707. The menu is then displayed or played to the user 709.

If a menu is not available, then the system checks to see if a saved menu exists 711. The saved menu could be saved locally on the system or on a remote server (a central server, at the restaurant, etc.)

If a saved menu exists, it is downloaded 713 and displayed 709. If no save menu exists, then an error message is presented 715.

In this exemplary system, menus can change constantly and, since the menu is assembled piecemeal, there should be little to no difficulty in presenting an updated menu. Preformatted and saved menus may also be used if desired.

Since the formatting for the menu may be generic, the “menu” can actually be used to present a variety of non-food goods as well. For example, if a movie ticket is to be purchased, where the menu options usually are can be a title of a movie and a list of show times. Then, where the food prices would be, could be a list of ticket prices.

This dynamically updatable menu allows for numerous restaurants using a standard data format to present menus. Since graphics, such as logos, can also be dynamically added, as well as color schemes, menus can be give a customized look using a generic framework.

FIG. 8 shows an illustrative example of a system for processing a payment to a merchant. In this illustrative example, the vehicle system or a central server accesses a payment source 801. This could be, but is not limited to, a stored amount on a vehicle-internal debit “card”, a credit card number, a bank account, etc.

Next, the system checks to see if there is sufficient money available to cover the payment 803. If there is insufficient funding, the system may notify the user 805. It may also give the option to provide alternative payment, or give the option for the user to pay upon pickup of the order.

If there is sufficient funding, the system then determines if a security check has been passed 805. Numerous non-limiting examples of security features have been provided herein.

If the security check is passed 807, the account is debited/charged for the order 809. Otherwise, an error message may again be displayed, and/or alternative payment method may be used, such as a directly input credit card.

What is claimed:

1. A method for making a purchase using a
vehicle computing system, comprising:
receiving input to the vehicle computing system instructing order initiation;
receiving a selection at the vehicle computing system of a merchant from which to order;
receiving an order at the vehicle computing system;
determining an address of the merchant to which the order was placed;
providing directions to the address; and
processing a payment for the order.

2. The method of claim 1, wherein the input instructing initiation of an order is a verbal command.

3. The method of claim 1, wherein the input instructing initiation of an order is a command entered on a touch screen included with a vehicle display.

4. The method of claim 1, wherein the selection of the merchant from which to order is a verbal command.

5. The method of claim 1, wherein the selection of the merchant from which to order is a command entered on a touch screen included with a vehicle display.

6. The method of claim 1, wherein the order is received via a verbal command.

7. The method of claim 1, wherein the order is received via a touch screen included with a vehicle display.

8. The method of claim 1, wherein the determining is done by the vehicle computing system.

9. The method of claim 1, wherein the determining is done by a central server in communication with the vehicle computing system through a connection established with a wireless device, in communication with both the vehicle computing system and the central server.

10. The method of claim 1, wherein the processing a payment further includes verifying that a security measure has been met.

11. The method of claim 10 wherein the security method includes a biometric.

12. The method of claim 10, wherein the security method includes detecting the presence of a key fob in a vehicle.

13. The method of claim 10, wherein the security method includes receiving an input of the answer to a predetermined question.

14. The method of claim 1, wherein the processing a payment further includes:
verifying that a balance sufficient to cover a price of the order is present on an account; and
charging the account for the price of the order.

15. The method of claim 14, wherein the account is a debit account and the balance is stored on the vehicle computing system.

16. The method of claim 14, wherein the account is a credit card account.

17. A method for making a purchase using a vehicle computing system, comprising:
establishing wireless communication over a local network between the vehicle computing system and a merchant system from which an order is to be placed;
providing a list of options which may be ordered;
receiving an order at the vehicle computing system;
transmitting the order to the merchant from the vehicle computing system; and
processing payment for the order.

18. The method of claim 17, further including sending one or more identifying traits of the vehicle to the merchant system.

19. The method of claim 17, wherein the list of options includes previously ordered options.

20. The method of claim 19, wherein the previously ordered options are stored in a memory of the vehicle computing system.

21. The method of claim 19, wherein the previously ordered options are stored remotely from the vehicle computing system in a remote storage and are downloaded by the vehicle computing system from the remote storage.

22. The method of claim 17, wherein the providing a list of options further comprises:
determining if a list of options is available for download from the merchant system;
dependant on the determining, downloading the list of options from the merchant system; and
presenting the downloaded list of options.

23. The method of claim 22, wherein the presenting further includes:
filling a template with the downloaded list of options; and
displaying the template on a vehicle display.

24. The method of claim 22, wherein the presenting further includes playing the downloaded list of options through a vehicle audio system.

25. The method of claim 17, wherein the presenting further includes:
determining if a list of options for a merchant corresponding to the merchant system has been previously saved; and
dependant on the determining, presenting the previously saved list of options.

26. A method for making a purchase using a vehicle computing system, comprising:
establishing communication between the vehicle computing system and a merchant system from which an order is to be placed;
providing a list of options which may be ordered;
receiving an order at the vehicle computing system;
transmitting the order to the merchant from the vehicle computing system;
processing payment for the order; and
sending one or more identifying traits of the vehicle to the merchant system.

27. The method of claim 26, wherein the merchant system is a central server in communication with a local computing system located at a merchant in the vicinity of the vehicle.
